(19) United States
(12) Patent Application Publication
(10) Pub. No.: US 2008/0278526 A1
(43) Pub. Date: Nov. 13, 2008

(54) Ink jet printer with expanded validation print zone

(75) Inventors: Donald E. Brooks, Ithaca, NY (US); Richard S. Quaif, Dryden, NY (US)

Correspondence Address: Lipsitz & McAllister, LLC, 755 MAIN STREET, MONROE, CT, 06468, US

(73) Assignee: TransAct Technologies Incorporated, Hamden, CT (US)

(21) Appl. No.: 12/151,481

(22) Filed: May 6, 2008

Related U.S. Application Data
(60) Provisional application No. 60/928,474, filed on May 8, 2007.

(51) Int. Cl. B41J 29/38

(52) U.S. Cl. 347/9

(57) ABSTRACT

An ink jet printer has two print cartridges. For example, one cartridge can carry black ink and the other red ink. Both cartridges are used to print on a receipt with a narrow print zone of, for example, 2.5 inches. Only the black cartridge is used to print on a cut sheet for validation purposes. By lengthening the time that the print head of the black cartridge is actuated to spray ink, a wider print zone (e.g., 3.5 inches) can be provided for the cut sheet.

This application claims priority from U.S. Provisional Patent Application No. 60/928,474 filed on May 8, 2007.

### FIELD OF THE INVENTION

This invention relates generally to the field of validation printers, and specifically to an ink jet validation printer that performs receipt printing as well as validation printing with an expanded print zone for validation printing.

### BACKGROUND OF THE INVENTION

A validation printer, also known as a cut sheet printer, enables both receipts and cut sheets such as bank checks or vouchers to be printed. The printing on a cut sheet is typically used for validation purposes, e.g., printing information on the back of a check to identify a particular transaction. An example of a prior art validation printer can be found in commonly assigned U.S. Pat. No. 6,435,679, incorporated herein by reference.

In the prior art validation printer illustrated in the '679 patent, a receipt is generated from a roll of paper that feeds up out of the printer in a first (e.g., vertical) direction. The width of the receipt paper defines a maximum print area width (from inside a left edge margin to inside a right edge margin) for the printer. As an example, the maximum print area width may be 2.5 inches. A cut sheet (such as a bank check) can be loaded into a slot in a second (e.g., horizontal) direction, and the print area width of the cut sheet is limited to the same maximum print area as the receipt, e.g., 2.5 inches.

In an ink jet printer, one or more ink cartridges (sometimes referred to as “pens”) are carried in a carriage back and forth across the substrate (e.g., receipt or cut sheet) to be printed. As the ink cartridges move across the substrate, print heads associated therewith selectively spray ink to print a desired pattern one line at a time. The substrate is moved perpendicular to the direction traveled by the ink cartridges, so that as the substrate progresses in, say, a vertical direction, the ink being sprayed in a horizontal direction will create successive lines in the correct pattern to form an image such as text and/or graphics on the substrate. Since it is the print heads that actually spray the ink onto the substrate, it is also conceivable to design a printer where only the print heads (e.g., nozzles) move, and the ink supply is stationary. Apparatus and control systems for moving and actuating ink jet print heads are well known in the art.

Prior art ink jet printers such as those illustrated in the '679 patent use two print heads to provide black ink or color ink, respectively. The print heads are actuated only for enough time to spray ink across the same distance regardless of whether a narrow receipt is being printed or a wider cut sheet is being printed. Thus, if black print is desired, the black print head will be actuated to spray ink only within the print zone of the receipt (e.g., 2.5 inches) which will be the same print zone provided for the cut sheet, even though the cut sheet may be longer. Similarly, if color print is desired, the color print head will be actuated to spray ink only within the print zone of the receipt, which will be the same print zone provided for the cut sheet. This limits the amount of text that can be used for each line of validation information printed on the cut sheet.

It would be advantageous to allow a wider print zone on the cut sheet, which can accommodate a wider line of print, than is provided for a narrow receipt. The present invention provides an ink jet printer that enjoys this and other advantages. In particular, the present invention actuates at least one of the print heads (e.g., the black ink print head) for a longer time period during the printing of a cut sheet than it actuates that print head during the printing of a receipt. The longer actuation period allows the ink to spray onto the cut sheet substrate for a longer time as the print carriage traverses the width of the cut sheet, resulting in a longer line of type than is provided on the narrower receipt substrate.

### SUMMARY OF THE INVENTION

In accordance with the invention, an ink jet validation printer is provided having a receipt paper path and a separate validation paper slot. The receipt paper path can receive individual receipts or can be fed by a continuous roll of paper. In one embodiment, the receipt substrate (e.g., paper) is fed up and out of the printer in a vertical direction. The validation paper slot is positioned between the receipt substrate and the path of the print head(s) that are used to print on the receipt substrate. Thus, when a cut sheet is inserted into the validation paper slot, it will be located in front of the receipt substrate, but behind the print head(s) so that printing will occur on the cut sheet instead of on the receipt substrate.

Software and/or firmware code is provided in the printer to detect the insertion of a cut sheet into the validation paper slot, and change the actuation time for one of the print heads upon such detection. For example, if the black print head is normally actuated for a time period sufficient to print a maximum 2.5 inch wide print zone on a receipt (which is all a receipt of that width could accommodate), it can be actuated for a longer time period to stay on and spray ink over a larger distance, say 3.5 inches, to provide a wider print zone for the cut sheet. Alternatively, a solely mechanical arrangement could be provided to serve this purpose. For example, a trip lever coupled, e.g., to a microswitch, could be actuated by the cut sheet, which lever would mechanically alter the allowable “on time” for the print head when printing on the cut sheet as opposed to the “on time” allowed for a narrower receipt.

As many ink jet printers have a carriage for transporting the print head(s) that is wider than the receipt paper, the additional space required to print a wider zone on the cut sheet is already available. In fact, in a printer having two ink cartridges (e.g., black and red), the carriage must be wide enough to enable both cartridges to traverse the width of the receipt, as well as to enter “spit and wipe” zones that are used to clean the print head of each cartridge. The present invention takes advantage of this fact and keeps the print head active over a greater width along the carriage so that a wider print zone can be provided for a cut sheet inserted into the validation slot of the printer.

### BRIEF DESCRIPTION OF THE DRAWINGS

For a better understanding of these and other objects of the present invention, reference will be made to the following detailed description of the invention which is to be read in connection with the accompanying drawing, wherein:

FIG. 1 is a perspective view illustrating a point of sale ink jet printer embodying the present invention;

FIG. 2 is an enlarged perspective view illustrating the form feeder mechanism and ink jet cartridge carriage of the printer shown in FIG. 1;

FIG. 3 is a partial enlarged sectional view taken along lines 3-3 in FIG. 2, wherein the ink jet cartridges are removed from the carriage;

FIG. 4 is a further enlarged sectional view showing the drive mechanism for moving a form into and out of the printing station;

FIG. 5 is a schematic front view of the form drive mechanism and apparatus for controlling the drive roller;

FIG. 6 is a perspective view of an ink jet printer in accordance with the invention having a receipt substrate exiting in a vertical direction and a validation slot for a horizontally displaced cut sheet;

FIG. 7 is a simplified cross sectional view of the printer showing a receipt and a receipt print zone as well as a cut sheet (check) and a wider check print zone; and

FIG. 8 is a flowchart illustrating a print process in accordance with the invention.

### DETAILED DESCRIPTION OF THE INVENTION

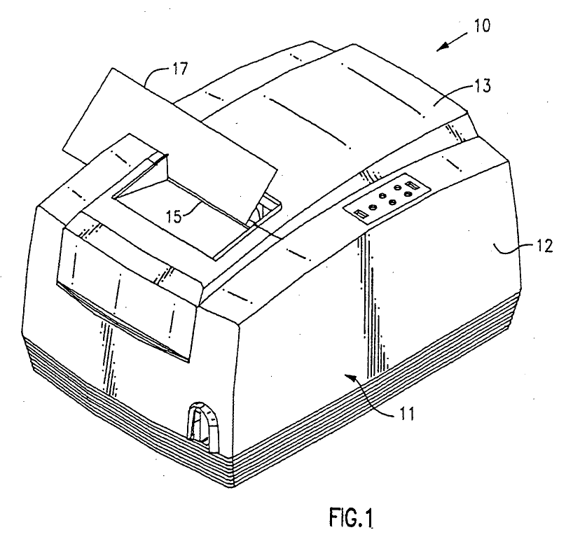

Turning initially to FIG. 1, there is illustrated a point of sale type printer, generally referenced 10, that embodies the teachings of the present invention. Although the present invention will be described with specific reference to a point of sale printer, it should be evident to one skilled in the art that the present invention has broader application and can be employed in conjunction with many different types of printers without departing from the teachings of the present invention. The printer 10 includes a housing 11 that contains a stationary base section 12 and a removable cover 13 that is hinged at the rear of the base so that the cover can be raised to provide access to the component parts mounted within the base. An elongated slit 15 is provided in the cover and the base section of the printer through which forms can be manually fed into a drive mechanism which will be described in greater detail below for transporting a cut sheet form into and out of the printing station of the machine. An elongated form 17 is shown situated within the slit. The form illustrated is a check that is being validated while in a plantation or right reading orientation. The term validation is used herein in the broadest sense of the word and can, among other things, include simply printing a notice upon a check that the instrument is for deposit only. Moreover, the cut sheet form can comprise any other form that a user needs to validate, such as a coupon, a voucher, a credit slip, a deposit slip, or the like.

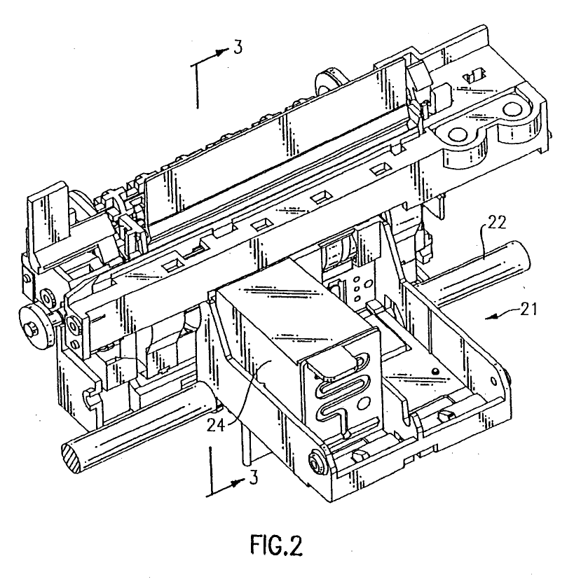

As further illustrated in FIGS. 2 and 3, a carriage 21 is arranged to ride along a horizontally disposed rail 22 so that the carriage can be reciprocated within a printing station generally referenced 23. The carriage is arranged to carry two ink jet cartridges 24, one of which is shown mounted within the carriage in FIG. 2. Each ink cartridge is equipped with one or more print heads (e.g., nozzles) that are adapted to apply ink images in the nature of letters or designs upon a form as the form is being transported through the printing station between the ink cartridges and a back-up platen roll 25. This type of ink jet printing is well known in the art and will not be discussed in detail herein except to say that the ink images are preferably laid down in a line by line sequence as the form is moved downwardly or upwardly through the printing station in response to an input from a programmable controller. By printing on the form as it moves downwardly through the printing station, ample time is provided for the ink images to set or dry before the form is withdrawn from the printer.

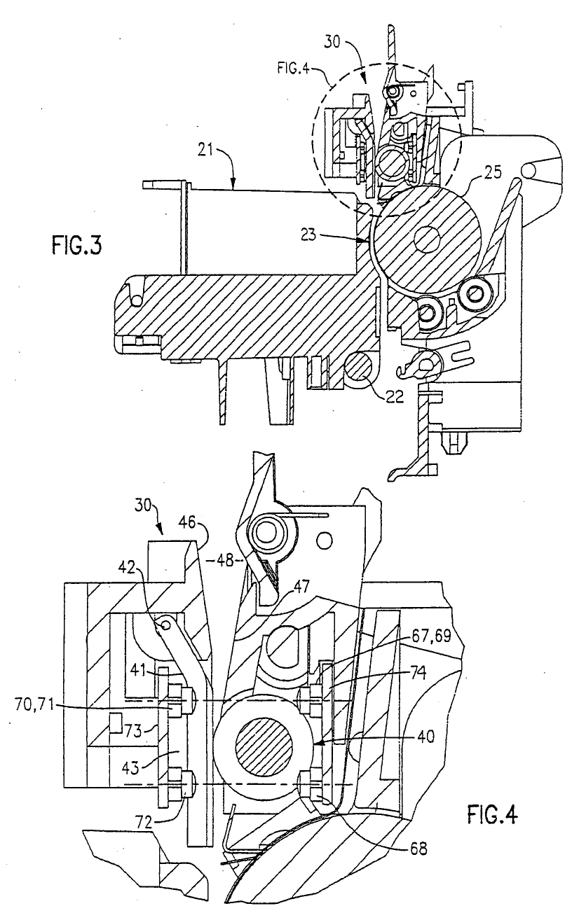

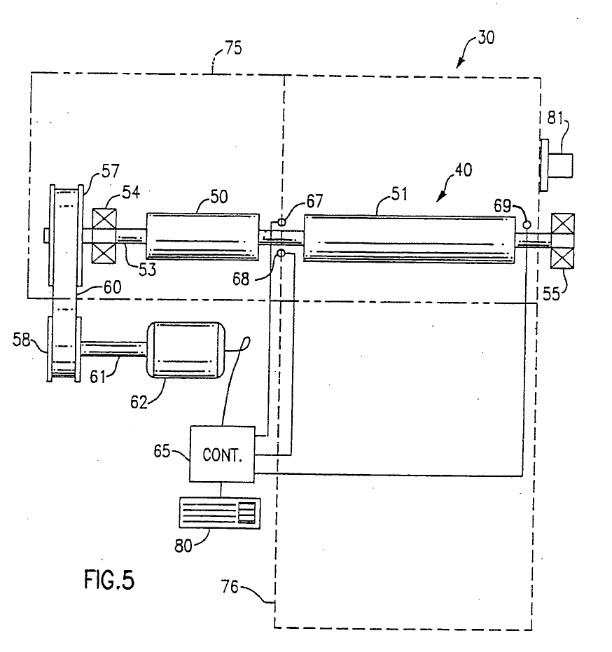

A forms feeder station generally referenced 30 is mounted directly above the printing station and is shown in greater detail in FIGS. 4 and 5. A horizontally disposed drive roller assembly 40 is mounted for rotation within the station and is arranged to act in concert with an opposing biasing plate 41. The plate is pivotally supported upon a pivot pin 42 and is biased toward the drive roller by at least one spring member 43 so that the plate is urged into contact with the drive roller to form a one point nip between the plate and the roller. A pair of canted guide members 46 and 47 are arranged to establish a converging chute 48 at the entrance to the nip. Once in the nip, the form is initially driven in a downward direction as the drive roller turns in counter-clockwise direction as viewed in FIG. 4. Reversing the direction of rotation of the roller will drive the form captured between the drive roller and the biasing plate in an upward direction until such time as the form clears the nip.

As further illustrated in FIG. 5, the drive roller assembly 40 is separated into two sections 50 and 51 that are mounted upon a common shaft 53. The shaft, in turn, is journalled for rotation between spaced apart bearings 54 and 55. One end of the shaft extends outwardly beyond bearing 54 and a timing pulley 57 is secured to the outboard end of the shaft. The pulley 57 is connected to a drive pulley 58 by means of a timing belt 60. The drive pulley, in turn, is secured to the drive shaft 61 of a stepper motor 62, the operation of which is controlled by the programmable controller 65 of the printer.

Drive roller sections 50 and 51 are spaced apart sufficiently to permit light emitting diodes 67 and 68 to be mounted above and below the shaft 53 between the rolling sections. A third light emitting diode 69 is mounted above the shaft at the opposite end of roller section 51. The three light emitting diodes are mounted upon a common circuit board 74 located on one side of the drive roller assembly. Three light detectors (phototransistors) 70-72 are mounted upon a common circuit board 73 situated on the opposite side of the drive roller assembly. Each detector is axially aligned with a light emitting diode to establish a sensor unit. The biasing plate, like the drive roller, is mounted in two sections to provide an uninterrupted light path between the light emitting diodes and the light detectors.

Each detector is connected to the programmable controller 65 of the machine and provides an output signal to the controller when the light path to the detector is broken by a form passing through the nip. Alternatively, a mechanical switch, such as a microswitch or the like can be used to sense a form inserted into the receiving slot. Such a microswitch would send a form detection signal to the controller, as well known in the art.

Forms may be manually fed into the receiving slot 15 of the machine in either a horizontal orientation as illustrated by form 75 shown in phantom outline in FIG. 5 or in a vertical orientation as illustrated by form 76 shown in dashed outline in FIG. 5. The host or machine operator selects a desired orientation for the form and instructs the controller of the selection and the validation data that is to be printed upon the form. This can be accomplished by means of a keyboard 80 or any other suitable input or address system known in the art.

A registration stop 81 is mounted within the machine adjacent the form receiving slot 15 against which one edge of the form is registered as the form is moved into the entrance region of the nip. The leading edge of a properly registered form will initially break the beams of light emitted by diodes 67 and 69 at about the same time sending a signal to the controller indicating that the form is properly registered and aligned and is ready to begin a validation sequence. Depending upon the selected form orientation, the controller will step the form downwardly in a line by line progression the required number of lines. This is accomplished by controlling the orientation of the stepper motor which steps the drive roller in coordination with the movement of the ink jet carriage so that the desired data is printed on the form as it moves downwardly in the line by line progression.

When the validation printing sequence is completed, the direction of rotation of the drive roller is reversed and the form is driven in an upward direction to clear the nip. As the trailing edge of the form exits the drive section, the light beam from light emitting diode 68, which has been previously broken by the form, is able to reach detector 72 and the detector provides a signal to the controller indicating that the validation sequence has been completed and the system is readied to begin a new validation sequence.

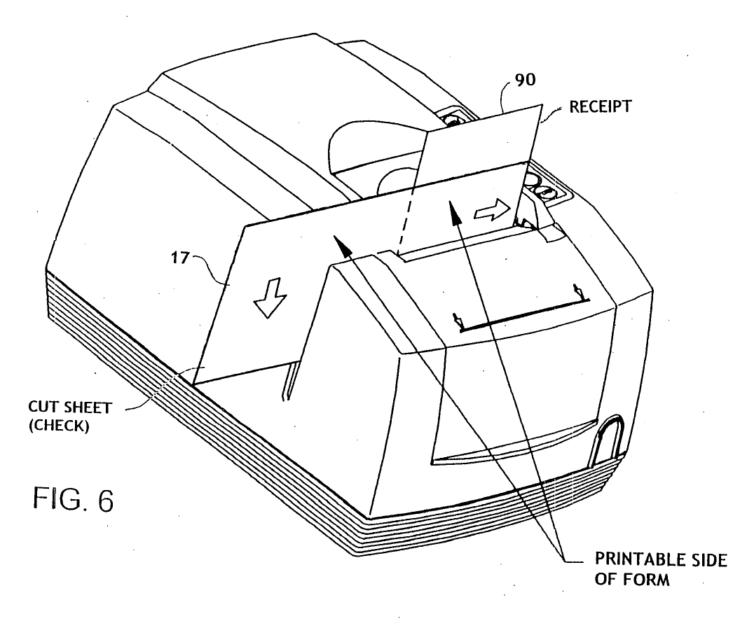

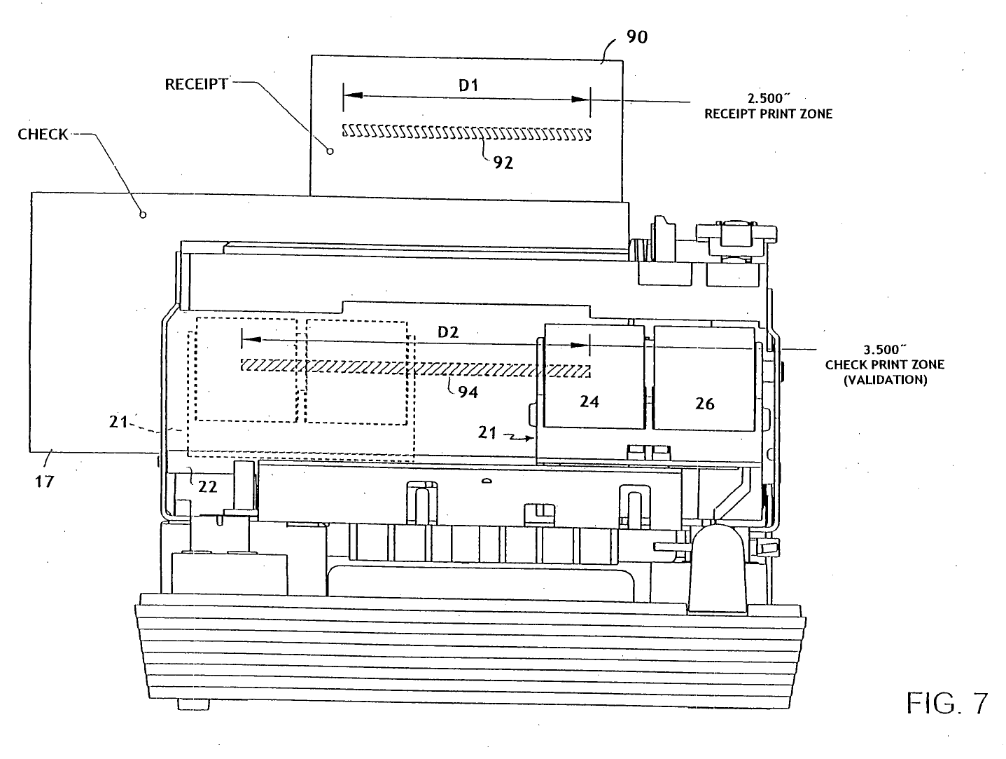

FIG. 6 illustrates the printer from the outside, when a receipt 90 is dispensed behind a cut sheet 17 (e.g., check) inserted into validation receiving slot 15. In operation, if no cut sheet 17 is inserted into the receiving slot 15, the printer will print onto the receipt 90. As the print zone for the receipt 90 cannot exceed the width of the receipt itself, the print head “on time” will be limited to no more than the receipt substrate width, typically 2.5 inches. In the event that a cut sheet is inserted into the receiving slot 15, the “on time” for the print head of ink jet cartridge 24 (FIG. 7) will be lengthened, in accordance with the invention, to enable the print head to spray ink over a width that is greater than the receipt substrate width, and can be accommodated on the cut sheet. This will establish a wider print zone for the cut sheet, which can, for example, be on the order of 3.5 inches. The width of this print zone is limited by the maximum travel of the print head carriage 21 along the carriage rail 22 within the printer, as illustrated in greater detail in FIG. 7. It is noted that if print cartridge 24 is a black ink cartridge, which is preferred, the validation print with the expanded print zone width will be in black. The timing for the print head of color ink jet cartridge 26 will not have to be altered, as it will only be used for printing on the receipt 90, which is the only substrate that this cartridge will substantially fully traverse.

As shown in FIG. 7, receipt 90 has a print zone 92 having its width defined by the distance D1 that both the first ink jet cartridge 24 (e.g., black ink) and the color ink jet cartridge 26 (e.g., red ink) can deposit ink onto the receipt 90. Since it is desired to allow both colors to be selectively printed across the entire print zone 92, the center of each cartridge 24, 26 (from which the associated print head sprays ink) must be capable of being transported by print carriage 21 from the rightmost edge to the leftmost edge of the print zone (i.e., the entire distance D1).

To the contrary, if only the ink from cartridge 24 (e.g., black ink) is desired to be deposited onto the cut sheet 17, then a wider print zone 94 can be provided for the cut sheet. This is illustrated by the distance D2 in FIG. 7, which extends from the center of cartridge 24 when the carriage 21 is in its rightmost position (solid lines), to the center of cartridge 24 when carriage 21 is in its leftmost position (dashed lines). In accordance with the present invention, by limiting the validation printing on the cut sheet to the ink from cartridge 24 (e.g., black ink), a wider print zone 94 can be provided. This feature can be implemented in the software and/or firmware that controls the printer, by lengthening the time that the print head associated with cartridge 24 is allowed to be on. Instead of turning the print head off at the leftmost edge of the receipt print zone 92, it is kept on until it reaches the leftmost edge of the validation print zone 94. Since the maximum travel of the carriage 21 on rail 22 is limited as the print heads traverse to the left, it is not possible to use the color cartridge 26 for the entire print zone 94. However, the second color provided by cartridge 26 is intended to be used only on the receipt 90, and not on the cut sheet 17, so this is not a significant problem. Validation requires only one color, preferably black, and this color can be provided by the cartridge 24 alone.

The movement of the carriage 21 carrying the print cartridges 24, 26 can be controlled by controller 65 (FIG. 5) or by a separate controller. Side-to-side movement of the carriage 21 can be accomplished using, for example, a servo motor and belt driven drive system, as well known in the art. Other electromechanical systems can be used instead of a belt driven servo motor system, as will be apparent to those skilled in the art. In such drive systems, an electronic controller is typically provided to control the movement of the carriage. In accordance with the present invention, an electronic controller is provided that is responsive to a sensed (or manually input) condition indicating that either a receipt or a cut sheet is to be printed. For example, optical or mechanical sensors well known in the art can be used to detect if a cut sheet has been inserted into the receiving slot 15. If no cut sheet has been inserted, the default printing operation can be one in which a receipt is printed.

If a receipt is to be printed (e.g., receipt 90 shown in FIG. 7), the controller will cause the carriage 21 to move while timing the “on time” of the applicable print cartridges such that ink is only sprayed within print zone 92. In the event that a cut sheet is to be printed, the controller will cause the carriage 21 to move while timing the “on time” of the print cartridge 24 such that ink can be sprayed across the expanded print zone 94. In this manner, the controller, which is responsive to the software and/or firmware of the printer, will allow a wider or expanded print zone for cut sheet printing.

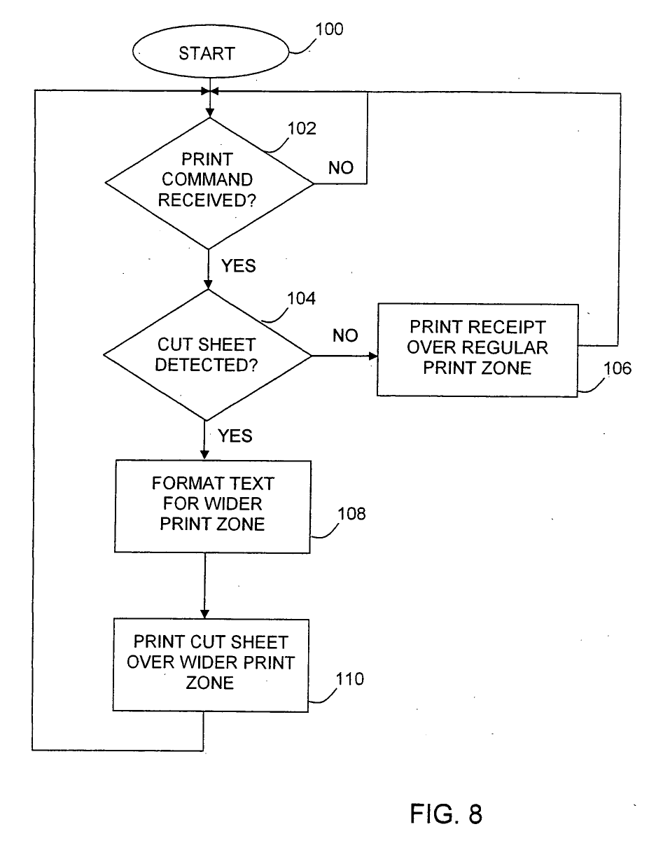

FIG. 8 is a flow chart illustrating the routine for printing across a regular print zone on receipts or across a wider print zone on cut sheets. The routine starts at box 100, and at box 102 a determination is made as to whether a print command has been received at the printer. If no print command has been received, the process loops back until a print command is received. Once a print command is received, the process flows to box 104, where a determination is made as to whether a cut sheet has been detected (e.g., in slot 15 of the printer). Such a determination can be made by an optical sensor, mechanical switch, or any other mechanism well known in the art. A manual switch could also be actuated to inform the printer that a cut sheet has been inserted.

If a print command has been received, but no cut sheet is detected, the process flows to box 106, where a regular receipt is printed in response to the print command. The receipt is printed within the narrower print zone provided on the receipt, in a conventional manner. The process then flows back to box 102, for the detection of the next print command.

If, on the other hand, a cut sheet is detected, then at box 108, the text (or other indicia) to be printed is formatted for the widened print zone. The process then flows to box 110, where the cut sheet is printed over the wider print zone that the cut sheet is capable of accommodating. The process flow then returns back to box 102, where the next print command is awaited.

While the present invention has been particularly shown and described with reference to the preferred mode as illustrated in the drawings, it will be understood by one skilled in the art that various changes in detail may be effected therein without departing from the spirit and scope of the invention as defined by the claims.

1. An ink jet printer for printing both receipts and cut sheets comprising:
a first print cartridge for printing in a first color;
a second print cartridge for printing in a second color;
a transport for moving said print cartridges with respect to receipts and cut sheets to be printed;
a print cartridge controller adapted to lengthen the print time for said first print cartridge when printing a cut sheet for validation purposes, thereby providing a wider print zone for said cut sheet than for a receipt.

2. An ink jet printer in accordance with claim 1 wherein said first color is black.

3. An ink jet printer in accordance with claim 1 wherein said receipts are printed on vertically oriented roll paper, and said printer includes a slot for manually inserting said cut sheets in either a horizontal or vertical direction.

4. An ink jet printer in accordance with claim 1 further comprising a separate receipt paper path and validation paper slot.

5. An ink jet printer in accordance with claim 4 further comprising a sensor for detecting a cut sheet inserted into said validation paper slot, said sensor being adapted to signal said controller to lengthen said print time.

6. An ink jet printer in accordance with claim 5, wherein said controller formats text to be printed on said cut sheet to extend along said wider print zone.

7. An ink jet printer in accordance with claim 1 wherein the print zone for said receipt is approximately 2.5 inches, and said wider print zone is greater than 2.5 inches.

8. A method for printing receipts and cut sheets comprising:
detecting the presence of one of a receipt or cut sheet in a printer;
printing indicia on said receipt or cut sheet by moving at least one print cartridge transversely with respect to the receipt or cut sheet to be printed; and
in response to said detecting step, lengthening the print time for said print cartridge when a cut sheet is detected, thereby providing a wider print zone for said cut sheet than for said receipt.

9. A method in accordance with claim 8 comprising the step of:
formatting text to be printed on said cut sheet to extend along said wider print zone.

10. A method in accordance with claim 9, wherein said formatting step is responsive to the detection of a cut sheet during said detecting step.

11. A method in accordance with claim 8 wherein:
two print cartridges are moved transversely with respect to the receipt or cut sheet to be printed; and
only one of said print cartridges is provided with a lengthened print time for printing across said wider print zone on said cut sheet.

12. A method in accordance with claim 11 comprising the step of:
formatting text to be printed on said cut sheet to extend along said wider print zone.
